(19) United States
(12) Patent Application Publication
(10) Pub. No.: US 2006/0056379 A1
(43) Pub. Date: Mar. 16, 2006

(54) System and method for network-assisted connection in a wireless environment

(75) Inventors: Robert D. Battin, Kildeer, IL (US); Ronald T. Crocker, St. Charles, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/940,533

(22) Filed: Sep. 14, 2004

(51) Int. Cl. H04J 3/24

(52) U.S. Cl. 370/349; 370/437

(57) ABSTRACT

A system and method establishes a data session between a mobile device and a destination server. A radio traffic channel is established between the mobile device and a radio network. At least partially simultaneous to establishing the radio traffic channel, the radio network establishes a connection between the mobile device and the destination server.

### FIELD OF THE INVENTION

The invention relates to networks and, more specifically, to transmitting information between different network elements.

### BACKGROUND OF THE INVENTION

In networks having different communication elements, the different components must communicate effectively with each other. If the elements malfunction or otherwise fail to communicate properly, poor communication quality often occurs. Poor communication quality results in an undesirable experience for a user.

In such systems, an application running on a user device, such as a cellular telephone, often attempts to communicate with a target host, such as an Internet server. In one approach, a communication session is established between the application and the target host using the Transportation Control Protocol (TCP). A TCP session is established when a user performs some action at an application requiring that the target host, such as a web server, be accessed. The application first tries to determine the target host's IP address using a naming service, typically Domain Name Server (DNS) resolution, via a standard application programming interface (API). One or more IP packets from the host are created, which are directed toward a radio interface connected to the application.

When the radio interface at the application accepts these packets, it begins the process of allocating a radio channel for the transmission of data packets. Once the radio channel is ready, naming service packets are transmitted from the application to a DNS server and domain name resolution occurs. The application can then initiate the TCP session and the data packets can be exchanged.

As described above, previous systems establish the TCP session only after the radio channel is allocated. Since TCP session establishment and radio channel allocation are performed sequentially, delays occur. Since these delays can be long, the experience of the user with the system is degraded and frustration with the delays often occurs. Previous systems also frequently require the use of additional hardware, such as RF timers, to ensure the proper timing of the system's actions, resulting in wasted RF capacity in the system.

### BRIEF DESCRIPTION OF THE DRAWINGS

FIG. 1 is a block diagram of a system for establishing a data session according to the present invention;

FIG. 2 is a call flow diagram showing the establishment of a session between a mobile-device and a destination server according to the present invention; and

FIGS. 3a-c are call flow diagrams showing the messages exchanged in the establishment of a data session according to the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

A system and method is provided for establishing a data session between a mobile device and a destination server. More specifically, a radio traffic channel is established at least partially simultaneous to performing domain name sever (DNS) resolution and establishing a transportation protocol (TCP) connection between the mobile device and the server. Advantageously, this approach results in faster establishment of the data session and a better user experience.

In many of these embodiments, an initiation message is sent to an intermediate unit or proxy. The message may include protocol information that is used to make a connection between a mobile device and a destination server. A first connection is established by the radio network between the intermediate unit and the destination server using the provided information. A second connection is thereafter established by the radio network between the intermediate unit and the mobile unit may be made by also using the provided information. A third connection is then established by the radio network between the mobile unit and the destination server using the first and second connections. The first, second and third connections are established substantially simultaneous to the establishment of the traffic channel between the mobile unit and the destination server. After the establishment of the third connection, the radio network may terminate the first and second connections and use the third connection as the communication path between the source and the destination.

The protocol information sent in the message may include high-level protocol information and low-level protocol information. High-level protocol information may include Hyper Text Transfer Protocol (HTTP) information, File Transfer Protocol (FTP) information, Session Initiation Protocol (SIP) information, Simple Mail Transfer Protocol (SMTP) information, Post Office Protocol (POP) information, or Intermediate Message Access Protocol (IMAP) information. Low-level protocol information may include a protocol ID, a source port number, and a destination port number.

In another approach, the initiation message may be a Reconnect message, a Data Burst message, or a Short Data Burst message. Further, the radio network employed may be a code division multiple access (CDMA)-2000 network, a Universal Mobile Telecommunications Systems (UMTS) network or a satellite network. Other examples of networks and communication protocols are possible.

Thus, a system and method is provided whereby traffic channel establishment and DNS resolution and TCP connection establishment occur substantially simultaneously. This results in fewer delays in the system thereby reducing user frustration and enhancing the user experience. In addition, no extra hardware is needed to implement the system, thereby reducing the cost of the system to the end-user.

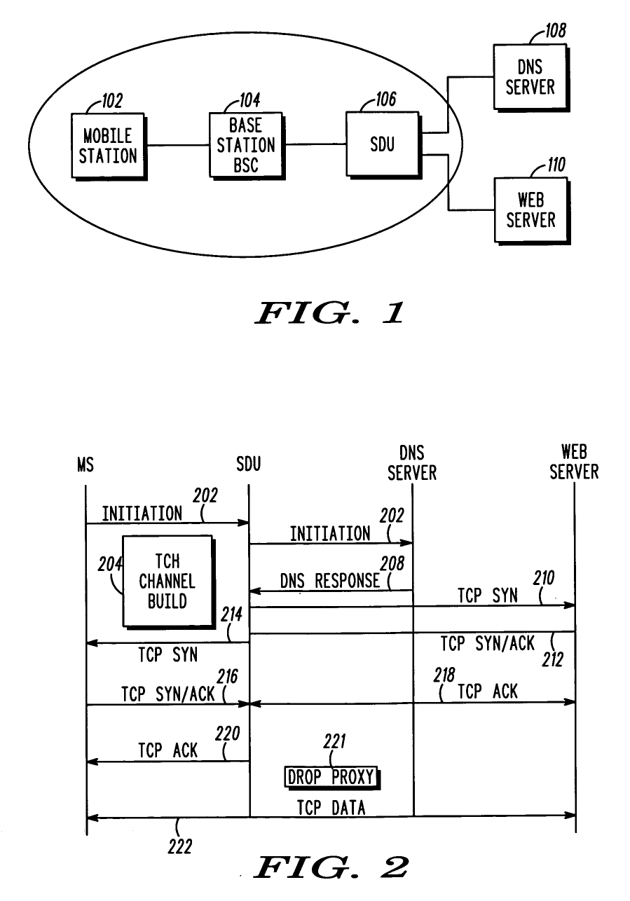

Referring now to FIG. 1, a system for establishing a data connection between a mobile station 102 and web server 110 is described. The mobile station 102 is connected to a base station and a base station controller (BSC) unit 104. The base station/BSC 104 is coupled to a proxy unit 106. The proxy unit 106 is coupled to a domain name server (DNS) 108 and web server 110.

The mobile station 102 may be any type of mobile wireless device. For example, it may be a cellular telephone, a personal digital unit (PDU), a pager, or the like. The base station/BSC 104 includes functionality to transmit and receive messages to and from the mobile station 102. The proxy unit 106 may be a part of the base station/BSC or located separately. As described herein, the proxy unit 106 ensures that radio channel allocation and TCP session initiation can occur substantially in parallel.

In this regard, the mobile unit 102 may send a message with TCP information to the proxy unit 106 via the base station/BSC 104. The proxy unit 106 performs destination name resolution using the DNS 108. The proxy unit 106 initiates a TCP session with the web server 110. Radio resources are allocated substantially simultaneously with the establishment of the TCP session. The proxy unit 106 initiates a TCP session with the mobile unit 102 and instructs the mobile unit to use specific sequence numbers. The proxy performs TCP session acknowledgement (ACK) to both the mobile unit 102 and the web server 110. The proxy unit 106 drops out of the flow (reverts to a passive mode) and the mobile unit 102 and the web server 110 communicate directly with each other.

In this approach, the user performs some action on an application to initiate a session, but the application only needs to make a single API call to a modified version of a connect( ) function. A modified connect( ) function takes all the normal( ) parameters and also allows for the usage of an unresolved host name. The connect( ) function then creates specific Short Data Burst (SDB) messages for transmission to a proxy control function (PCF) included in the proxy unit 106.

The connect( ) function also posts a listen requirement on the TCP port being used. The SDB contains either the unresolved host name or resolved host IP address, the destination TCP port number, and the source TCP port number. The mobile and PCF then begin processing in parallel. The mobile performs the procedures needed to obtain radio resources. The PCF performs a name resolution on behalf of the mobile if needed. The PCF then initiates the TCP session to the destination host by sending a TCP SYN message. The PCF uses the source IP address of the mobile and the TCP port supplied in the SDB. The TCP Sequence Number is selected as specified in the Host Requirements RFC.

During this phase of operation, the PCF intercepts all traffic bound for the mobile. When the TCP SYN/ACK message from the destination host arrives, the PCF consumes that message and stores the TCP Sequence value. The PCF then creates a TCP SYN message for delivery to the mobile. The TCP SYN message uses the TCP Sequence value from the destination host's TCP SYN/ACK message. The TCP SYN message also contains a newly defined TCP option. This option allows the host sending the TCP SYN message to specify the starting sequence number for the other side of the TCP connection. The TCP SYN message is delivered to the mobile as soon as radio resources are established.

The mobile responds to the TCP SYN message with a TCP SYN/ACK message of its own. The PCF would again intercept this message and then creates a TCP ACK message to be sent to the destination host and a TCP ACK message to be sent to the mobile host. The PCF then exits the communication session and the destination host and mobile host each may begin user data transmission.

The approach described above can be used in protocols such as the User Datagram Protocol (UDP). In this case, the protocol ID must also be sent in the SDB and, in the case of UDP, there is no three-way handshake to place in parallel with the radio resource allocation. Another approach involves modifying a write( ) function call to include the parameters found in the new connect( ) function. By doing this, the actual contents of the write function, such as an HTTP “get filename”, can also be included in the SDB. The actual retrieval of user data can then be initiated while the radio channel is being allocated. This can provide for additional response time gains and potential improved channel scheduling at the cost of increased size to the SDB and a complicated rendezvous scheme for sequence number management.

Referring now to FIG. 2, a call-flow diagram showing the message flow between a mobile unit and destination server is described. At step 202, an initiation message is sent from the mobile unit to the proxy. The initiation message includes both low-level and high-level protocol information. The information may be explicit (name of protocol) or inherent (certain port numbers to be used). At step 206, the initiation message is reformatted and transmitted to the DNS. The DNS responds at step 208 with a DNS response message.

At step 210, the proxy sends a TCP SYN message to the destination server. At step 212 the destination server responds with a TCP SYN/ACK message indicating that the connection is ready to be established. These messages and their formats are well known to those skilled in the art.

At step 214, the proxy sends a TCP/SYN message to the mobile station. At step 216, the mobile station responds with a TCP SYN/ACK message. The completion of this handshaking indicates that a communication path exists between the proxy and the mobile.

At step 218, the proxy sends a TCP/ACK message to the destination server. This message indicates to the destination server that TCP/IP data can flow from the destination server to the proxy. This step may also occur after step 212 is performed, in another approach.

At step 220, a TCP ACK message is sent from the proxy to the mobile station indicating that data can flow from the mobile station to the proxy. At step 221, the proxy is dropped from the data flow and at step 222 TCP data flows between the mobile device and the destination server.

The step 204, a TCH channel build is accomplished. This may include, for example, mobile assignment, channel assignment, and the sending of data. Step 204 is performed simultaneously with all or some of the steps 202-222.

Thus, the above-described system and method allows traffic channel establishment and DNS resolution and TCP connection establishment to occur substantially at the same time. Increased system performance results since delays in establishing communications are significantly reduced.

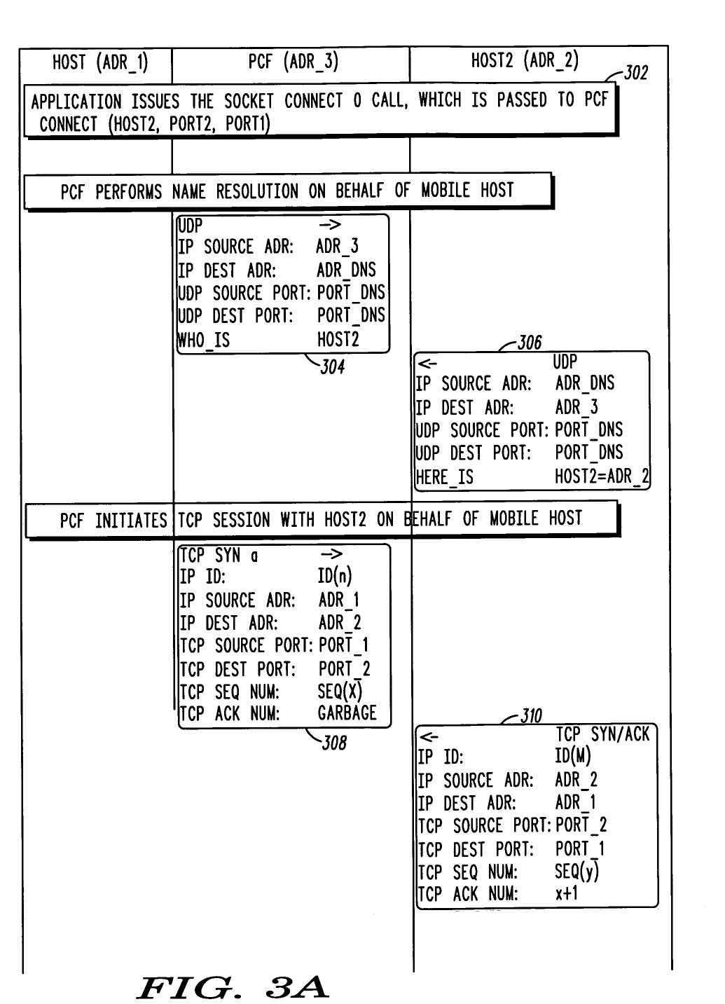

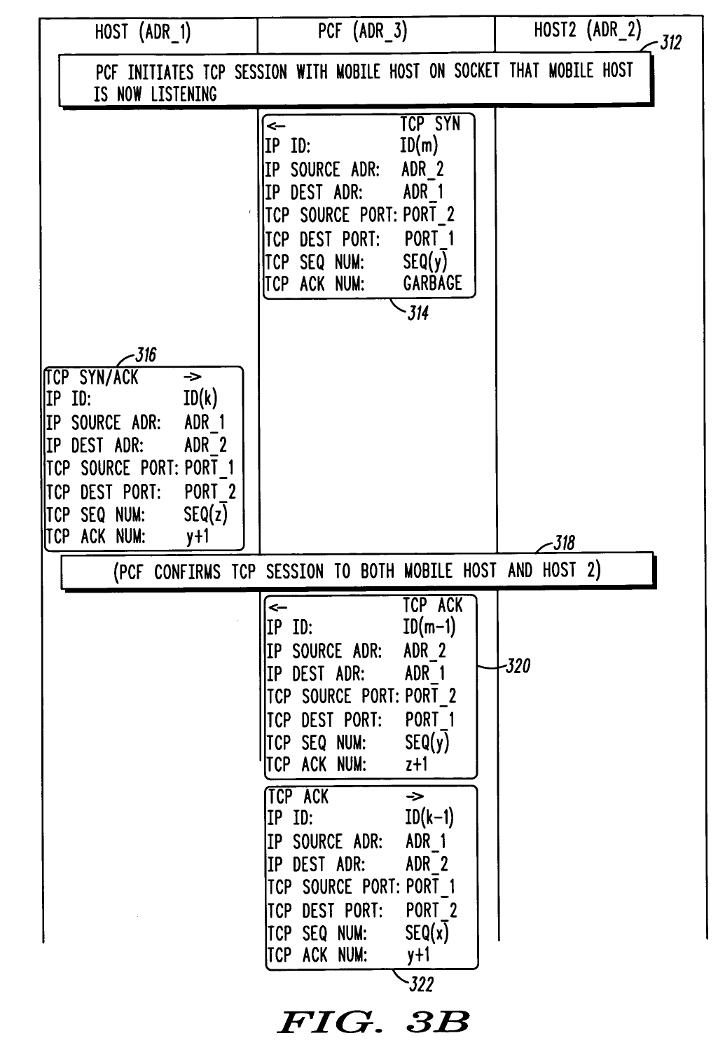

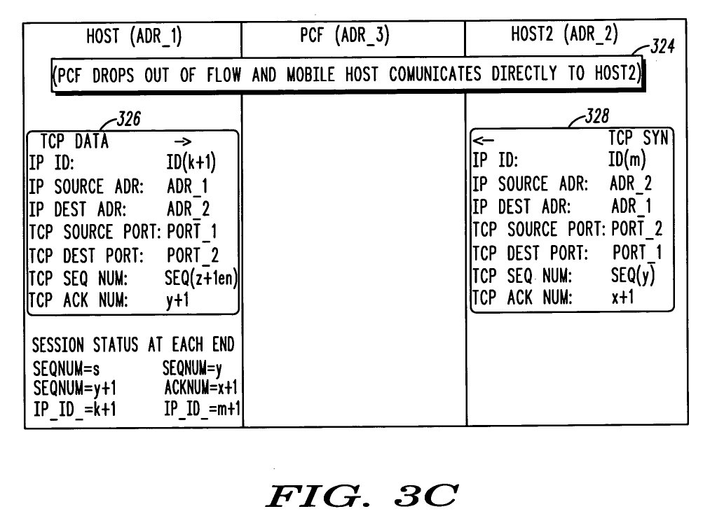

Referring now to FIGS. 3a-c, the messaging sequence between a first host (e.g., a mobile device) and a second host (e.g., a destination server with name xyz.com) is described. The method uses a PCF to act as intermediary between the first host and the second host. At step 302, the application (on the first host) issue a socket connect command, which is passed to the PCF.

In one example, the connect message includes three parameters. The first parameter is the name of the destination, for example, the second host. The second parameter is the high-level protocol port number, for example, port 2. The third parameter is the port number of a low-level protocol, for instance, port 1.

At step 302, the PCF performs name resolution on behalf of the first host (e.g., the mobile device). In this case, a DNS request message 304 is formed with IP source address of Adr_3 (the address of the PFC), IP Destination address of Adr_DNS (the address of DNS), and UDP destination port of Port_DNS.

A DNS reply message 306 is formed at the host server. The message 306 includes a source IP address of Adr_DNS, destination IP address of Adr_3, UDP source port of Port_DNS and the UDP Destination port of Port_DNS.

At step 308, the PCF initiates communications with the second host on behalf of the first host. A TCP-SYN message 310 is sent from the PCF to second host and a TCP Syn/Ack message is sent from the second host to the PCF. Both messages include TCP sequence numbers, source and destination address information, and source and destination port information.

At step 312, a TCP session is initiated with the mobile host on a socket on which the mobile host is listening. A TCP SYN message 314 is sent from the PCF to the first host. A TCP SYN/ACK message 316 is sent from the first host. The messages include IP addressing, port and sequence number information.

At step 318, the PCF confirms that TCP sessions between the PCF and the first host, the PCF, and the second host. In this regard, a TCP ACK message 320 is sent from the PCF to the first host and a TCF ACK message 324 is sent from the PCF to second host. Both messages include IP addressing information, port information, and sequence number information. The message 322 could also be sent at a different time, for instance, after message 310 is sent.

At step 326, the PCF drops out of the messaging flow and the first host communicates directly with second host. In this case, TCP data 328 can be sent from the first host to the second host and TCP data 330 can be sent from second host to the first host. The TCP data includes the appropriate source and destination addresses so that the data can be routed correctly. Port information as well as sequence number information and acknowledgment number information is also included.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method for establishing a data session between a mobile device and a destination server comprising:
establishing a radio traffic channel between the mobile device and a radio network; and
at least partially simultaneous to establishing the radio traffic channel, establishing, by the radio network, a connection between the mobile device and the destination server.

2. The method of claim 1, wherein establishing the radio traffic channel between the mobile device and the radio network and establishing the connection between the mobile device and the destination server are initiated by a first message.

3. The method of claim 2, wherein sending the first message comprises sending an initiation message to the radio network, the initiation message comprising radio network information used to establish the radio traffic channel between the mobile device and the radio network, and protocol information used by the radio network to establish the connection between the mobile device and the destination server.

4. The method of claim 3 wherein establishing the connection comprises:
establishing, by the radio network, a first connection between the radio network and the destination server using the protocol information;
establishing, by the radio network, a second connection between the radio network and the mobile unit using the protocol information;
establishing, by the radio network, a third connection between the mobile unit and the destination server by utilizing the first and second connections; and
terminating, by the radio network, the first and second connections upon the establishment of the third connection.

5. The method of claim 3 wherein sending the initiation message to the radio network comprises sending a message selected from a group comprising a Reconnect message, a Data Burst Message, and a Short Data Burst Message.

6. The method of claim 5 wherein the protocol information comprises high level protocol information and low level protocol information.

7. The method of claim 6, wherein the high level protocol information includes information selected from a group of information comprising: Hyper Text Transfer Protocol (HTTP) information, File Transfer Protocol (FTP) information, Session Initiation Protocol (SIP) information, Simple Mail Transfer Protocol (SMTP) information, Post Office Protocol (POP) information, and Intermediate Message Access Protocol (IMAP) information.

8. The method of claim 6 wherein the low-level protocol information comprises protocol ID, a source port number, and a destination port number.

9. The method of claim 1, wherein establishing the connection between the mobile device and the destination server comprises determining, by the radio network, a destination address corresponding to the destination server.

10. The method of claim 1 wherein establishing a radio traffic channel is performed in a network chosen from a group comprised of a code division multiple access (CDMA)-2000 network, Universal Mobile Telecommunications System (UMTS) network, a General packet Radio System (GPRS) network, and a satellite network.

11. A proxy device in a radio network for facilitating a connection between a destination server and a mobile device on a radio network comprising:
a receiver for receiving an initiation message, the initiation message comprising protocol information; and
a processor, the processor coupled to the receiver and receiving the protocol information and initiating connection and resolution messages with the destination server and, responsively, receiving messages from the destination server, the connection and resolution messages being sent and received to and from the destination server at least partially simultaneous with radio channel establishment on the radio network.

12. The proxy device of claim 11 wherein the initiation message comprises a message selected from a group of messages comprising a Reconnect message, a Data Burst Message, and a Short Data Burst message.

13. The proxy device if claim 11 wherein the radio network is chosen from a group comprised of a code division multiple access (CDMA)-2000 network, a Universal Mobile Telecommunications System (UMTS) network, a General Packet Radio System (GPRS) network, and a satellite network.

14. The proxy device of claim 11 wherein the processor comprises means for reverting to a passive mode once the radio channel establishment is completed.

15. The proxy device of claim 11 wherein the connection and resolution messages are used for DNS resolution and TCP connection establishment.

16. The proxy device of claim 11 wherein the protocol information comprises information indicating a high-level protocol information and a low-level protocol information.

17. A system for establishing a data session between a destination server and a mobile device comprising:
a destination server;
a proxy device in a radio network, the proxy device coupled to the destination server; the radio network establishing a traffic channel with the destination server, the proxy device receiving an initiation message from the radio network, the initiation message including protocol information, the proxy device initiating connection and resolution messages with the server and, responsively, receiving messages from the destination server, the messages being sent and received from the destination server at least partially simultaneous with radio channel establishment on the radio network.

18. The system of claim 17 wherein the initiation message is a message selected from a group comprising a Reconnect message, a Data Burst message, and a Short Data Burst message.

19. The system of claim 17 wherein the network is chosen from a group comprised of a code division multiple access (CDMA)-2000 network, a Universal Mobile Telecommunications System (UMTS) network, a General Packet Radio System (GPRS) network, and a satellite network.

20. The system of claim 17 wherein the proxy device includes means for reverting to a passive mode once the radio channel is established on the radio network.

21. The system of claim 17 wherein the connection and resolution messages exchanged between the proxy device and the server are used for DNS resolution and TCP connection establishment.
